(19) United States
(12) Patent Application Publication
(10) Pub. No.: US 2010/0249297 A1
(43) Pub. Date: Sep. 30, 2010

(54) NOVEL NANOPARTICLES

(76) Inventors: Jens Christoph Thies, Eijsden (NL); Pascal Jozef Paul Buskens, Heerlen (NL)

Correspondence Address: NIXON & VANDERHYE, PC, 901 NORTH GLEBE ROAD, 11TH FLOOR, ARLINGTON, VA, 22203, US

(21) Appl. No.: 12/676,084

(22) PCT Filed: Sep. 3, 2008
(86) PCT No.: PCT/EP2008/061608

§ 371 Date: Jun. 19, 2010

(30) Foreign Application Priority Data
Sep. 5, 2007 (EP) 07017371.1

(51) Int. Cl. C08K 5/5415

(52) U.S. Cl. 524/261; 977/773

(57) ABSTRACT

The invention provides a composition comprising core-shell nanoparticles, the nanoparticles comprising (a) cationic core material comprising latex; and (b) shell material comprising metal oxide.

The present invention is concerned with novel nanoparticles. More specifically, the invention relates to core-shell silica-polymer nanoparticles, methods for their preparation, and their potential uses.

There is growing academic and industrial interest in the synthesis and applications of nanoparticles, most particularly nanoparticles having a core-shell structure in view of their many potential uses such as delivery vehicles for active materials or in various types of coatings. Consequently, much prior art is devoted to the preparation of nano-sized particles of this type.

However, prior art methods for preparing these types of core-shell particles have proved difficult and unwieldy to use in anything other than lab scale. For example, the processes may be prohibitively expensive, lengthy, or may require non-ideal conditions. Or they may use hazardous reagents or produce hazardous by-products. Some such problems are illustrated in the paper entitled ‘Versatile Synthesis of Nanometer Sized Hollow Silica Spheres’ (Miller et al., Chem. Commun., 2003, 1010-1011) which describes the production of silica coated zwitterionic latex nanoparticles by means of depositing silicic acid on functionalised polystyrene. The deposition takes 24 hrs and is performed at ph 9.7. Unreacted silicic acid is removed by dialysis. The authors failed to form core-shell particles when they used anionic or cationic functionalised latexes.

It is apparent, therefore, that there is scope for the development of alternative nano-sized particles, which may be obtained using convenient reaction conditions.

According to a first aspect of the present invention, there is provided a composition comprising core-shell nanoparticles, wherein said nanoparticles comprise:

(a) cationic core material comprising latex; and

(b) shell material comprising metal oxide.

In a particular embodiment of the invention there is provided a coating composition comprising core-shell nanoparticles, wherein said nanoparticles comprise:

(a) cationic core material comprising latex; and

(b) shell material comprising metal oxide, preferably silica,

wherein said nanoparticles have a rod or worm-like morphology.

According to a further aspect of the present invention, there is provided a thin-film coating comprising the present core-shell nanoparticles.

According to a further aspect of the present invention, there is provided a process for forming a coating, the process comprising:
(a) applying a composition comprising the present core-shell nanoparticles to a substrate; and
(b) curing said composition wherein the polymer core cationic core material is at least partially removed.

According to a further aspect of the present invention, there is provided a substrate at least partially coated with a coating comprising the present core-shell nanoparticles.

According to a further aspect of the present invention, there is provided an article comprising a substrate at least partially coated with a coating comprising the present core-shell nanoparticles.

According to a further aspect of the present invention, there is provided a thin-film coating comprising the present core-shell nanoparticles. As used herein, “thin-film” refers to coatings having an average thickness of 1000 nm or less, more commonly 300 nm or less.

According to a further aspect of the present invention, there is provided a composition adapted to facilitate controlled delivery of at least one active agent into a system, said composition comprising the present core-shell nanoparticles, wherein said composition is adapted to provide said controlled delivery in response to controlled changes in the pH of said system.

Preferred examples of said active agent include, for example, drugs, dyes and catalysts, and suitable systems into which they might be delivered include such diverse examples as human and animal bodies, coatings and chemical reactors.

According to a further aspect of the present invention, there is provided an optical coating, especially thin-film optical coatings, comprising the present core-shell nanoparticles. As used herein, the term “optical coatings” refers to coatings with an optical function as major functionality. Examples of optical coatings include those designed for anti-reflective, anti-glare, anti-dazzle, anti-static, EM-control (e.g. UV-control, solar-control, IR-control, RF-control etc.) functionalities. Preferably the present coatings have an anti-reflective functionality. More preferably the present coatings are such that, when measured for one coated side at a wavelength between 425 and 675 nm (the visible light region), the minimum reflection is about 2% or less, preferably about 1.5% or less, more preferably about 1% or less.

As used herein, the term “nanoparticles” refers to particles whose primary average particle size is less then 300 nm, preferably less than 200 nm, more preferably less than 100 nm. Particle size can be measured by Dynamic Light Scattering (DLS) and Transmission Electron Microscopy (TEM).

As used herein, the term “core-shell” refers to particles comprising core material that comprises polymeric material (for example, homopolymers, random co-polymers, block-copolymers etc.) and shell material that comprises metal oxide (for example, silica, alumina, titania, tin oxide etc.).

As used herein, the term “binder” refers to a substance that can physically or chemically cross-link the nanoparticles and, preferably, also link the particles and substrate.

As used herein, the term “by weight of the solid fraction” refers to the weight percentage after removal of all solvent including water.

Unless otherwise stated all references herein are hereby incorporated by reference.

Throughout the description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith.

The nanoparticles for use in the present invention can be of any suitable size. Preferably the particles have an average specific size g where g=½×(length+width) of about 300 nm or less. More preferably the particles have an average size of about 200 nm or less. Even more preferably the particles have an average size of about 100 nm or less. Preferably the particles have an average size of 1 nm or more. More preferably the particles have an average size of about 10 nm or more.

Preferably the average specific size of the core is 1 nm or more, more preferably 3 nm or more, even more preferably 6 nm or more. Preferably the average specific size of the core is 100 nm or less, more preferably 80 nm or less, even more preferably 70 nm or less.

Preferably the shell is at least 1 nm thick, more preferably at least 5 nm, even more preferably at least 10 nm. Preferably the shell is 75 nm thick or less, more preferably 50 nm or less, even more preferably 25 nm or less.

The nanoparticles may comprise a mixture of different types, sizes, and shapes of particles. However, preferably the nanoparticles are relatively monodispersed, that is of a reasonably uniform size and shape.

In one embodiment the particles used herein are non-spherical such as, preferably, rod-like or worm-like particles. In another preferred embodiment the particles are substantially spherical.

In a preferred embodiment the void fraction is preferably from about 5% to about 90%, more preferably from about 10% to about 70%, even more preferably from about 25% to about 50%. The void fraction (x) may be calculated according to the following equation:

x=(4πrₐ³/3)÷(4πr_{b}³/3)×100

wherein rₐ is the radius of the core and r_{b} is the total radius.

The nanoparticles for use herein comprise cationic core material which comprises latex. Preferably the core comprises about 30% or more, more preferably about 50% or more, even more preferably about 70% or more, even more preferably still about 90% or more, by weight, of latex.

As used herein, the term ‘latex’ refers to stabilized suspension of polymeric particles. Preferably the suspension is an emulsion. Preferably the latex is cationic. The cationic group may be incorporated in to the polymer or may be added in any other form such as, for example, by the addition of a cationic surfactant. Preferably the cationic groups are at least partially bound to the polymer. Preferably the cationic groups are incorporated into the polymer during polymerisation.

Preferably the average size of the polymeric particles is in the range 1-300 nm, more preferably 10-200 nm, even more preferably 30-100 nm. Preferably the pH range of the suspension is from 3 to 7, more preferably from 3.5 to 6.

Preferably the latex comprises polymer and cationic surfactant. Preferably, the surfactant comprises ammonium surfactant.

Any suitable polymer may be used such as, for example, homopolymers, random co-polymers, block-copolymers, diblock-copolymers, triblock-copolymers, and combinations thereof.

The latex preferably comprises an aqueous cationic vinyl polymer.

Preferably, the latex comprises a polymer comprising styrene monomers, (meth)acrylic monomers, copolymers or combinations thereof.

In the present invention it may be required to remove some or all of the core material from the particle. This may be achieved in any suitable manner at any suitable point in the production process. Preferred methods include, for example, thermodegradation, photodegradation, solvent washing, electron-beam, laser, catalytic decomposition, and combinations thereof. Preferably the core is removed after the nanoparticles has been added to a coating or a composition that is used in forming a coating. Therefore, the scope of the present invention encompasses optical coatings comprising core-shell nanoparticles where the core is present and where the core has been partially or fully removed.

In a preferred embodiment the core comprises thermo-degradable or thermo-labile latex. Preferred are those which become labile at 600° C. or less, more preferably 450° C. or less, even more preferably 350° C. or less. Preferably the latexes become labile at room temperature or higher, more preferably 150° C. or higher, even more preferably 250° C. or higher.

The nanoparticles of the present invention comprise shell material which comprises metal oxide. Any suitable metal oxide may be used but negatively charged species are preferred. Preferred are sols derived from metal alkoxides. Preferably the metal oxide is selected from titanium dioxide, zirconium oxide, antimony doped tin oxide, tin oxide, aluminium oxide, silicon dioxide, and combinations thereof.

Preferably the shell comprises silica. More preferably the shell comprises at least 90%, by weight, of silica.

Preferably, said shell material comprises silica which is deposited on said core material from at least one silica precursor. Optionally, said at least one silica precursor may comprise an inorganic silicate, for example an alkali metal silicate, such as sodium silicate. However, preferred silica precursors comprise organosilicate compounds, especially alkyl silicates such as tetramethyl orthosilicate or tetraethyl orthosilicate. Most preferably, said silica precursor comprises tetramethyl orthosilicate.

Deposition of shell material may be carried out in any suitable manner. For example, the cationic core may be simply treated with suitable silica precursors under mild conditions.

Preferably the deposition is carried out at a pH of from 1 to 9, more preferably from 2 to 8, even more preferably from 3 to 7. In certain preferred embodiments the pH range for the deposition reaction is between 3.5 and 4.5. However, the optimal pH range is somewhat dependent on the reagents used.

More than one layer metal oxide may be deposited in the shell. In certain embodiments a layer of one metal oxide (e.g. silica) will be deposited followed by a layer of a different metal oxide (e.g. titania). This provides different properties to the nanoparticles.

The invention will now be further illustrated, though without in any way limiting the scope of the disclosure, by reference to the following examples.

### EXAMPLES

### Example 1

NeoCryl XK-30 latex (35.28 g) was diluted with water (80.0 g) and subsequently treated with tetramethoxysilane (41.2 g, addition rate 28 g·h⁻¹). After complete addition of TMOS, the resulting mixture had a pH of 4.00 and was then stirred at room temperature for an additional 90 minutes. The mixture was then poured into ethanol (867.0 g) under vigorous stirring with a stirring bar. The properties of the resultant particles were then assessed.

| pH after dilution with ethanol: | 5.68 | |
|---|---|---|
| Particle size latex in water (determined by DLS): | 86 | nm |
| Particle size core-shell particle water (determined by DLS): | 108 | nm |
| Particle size core-shell in ethanol (determined by DLS): | 147 | nm |
| Polydispersity: | <0.1 | |
| Isoelectric point (IEP): | 4-5 | |
| Particle size core-shell after drying (determined by TEM): | 75 | nm |
| Shell thickness after drying (determined by TEM): | 13 | nm |

Nitric acid was then added to a pH of 3.58. The particle size was stable at 115 nm for at least two weeks.

### Example 2

NeoCryl XK-30 latex (35.28 g) was diluted with water (80.0 g), treated with a 10 wt-% solution of acetic acid in water (15.0 g) and subsequently treated with tetraethoxysilane (56.5 g, addition rate 19 g·h⁻¹). After complete addition of TEOS, the mixture was stirred at room temperature for an additional 90 minutes. Then, the mixture was poured into ethanol (867.0 g) under vigorous stirring with a stirring bar.

| | |
|---|---|
| Particle size core-shell particle water (determined by DLS): | 100 nm |

1. A composition comprising core-shell nanoparticles, wherein said nanoparticles comprise:
(a) cationic core material comprising latex; and
(b) shell material comprising metal oxide.

2. A composition according to claim 1 wherein the average specific size of the nanoparticles is 300 nm or less.

3. A composition according to claim 1 wherein the latex comprises cationic polymer.

4. A composition according to claim 1 wherein the latex comprises an aqueous cationic vinyl polymer.

5. A composition according to claim 1, wherein the latex comprises a polymer comprising styrene monomers, (meth)acrylic monomers, copolymers or combinations thereof.

6. A composition according to claim 1, wherein metal oxide is silica.

7. A composition according to claim 1, wherein metal oxide is in the form of sols derived from metal alkoxides.

8. A composition according to claim 1, wherein metal oxide is added in the form of tetramethyl orthosilicate, tetraethyl orthosilicate, or combinations thereof.

9. A composition according to claim 1, wherein the shell material comprises more than one type of metal oxide.

10. A substrate at least partially coated with a composition according to claim 1.

11. A process for producing core-shell nanoparticles, said process comprising:
(a) providing a cationic core material comprising latex; and
(b) coating said core with a shell material comprising metal oxide.
wherein the shell material is added at a pH of from 1 to 7.

12. Use of a composition according to claim 1, in a thin-film coating.
